(19) United States
(12) Patent Application Publication
(10) Pub. No.: US 2026/0356087 A1
(43) Pub. Date: Nov. 12, 2026

(54) BED MESH BONDING DEVICE AND BED MESH BONDING METHOD

(71) Applicant: Guangzhou Lianrou Machinery & Equipment Co., Ltd, Guangzhou City (CN)

(72) Inventors: Zhiming TAN, Guangzhou City (CN); Zhiliang TAN, Guangzhou City (CN); Jie LIANG, Guangzhou City (CN)

(73) Assignee: Guangzhou Lianrou Machinery & Equipment Co., Ltd, Guangzhou City (CN)

(21) Appl. No.: 19/411,505

(22) Filed: Dec. 8, 2025

(30) Foreign Application Priority Data
May 8, 2025 (CN) 202510588410.0

(51) Int. Cl. B32B 38/18; B32B 37/12

(52) U.S. Cl. CPC B32B 38/18; B32B 37/1284

(57) ABSTRACT

A bed mesh bonding device includes: a feeding mechanism configured for providing a spring string; an assembly platform arranged at a first side of the feeding mechanism in a second direction, wherein the assembly platform is configured for bearing a bonded bed mesh; a pushing mechanism arranged at a second side of the feeding mechanism in the second direction, wherein the pushing mechanism is configured for pushing the spring string from the feeding mechanism to the assembly platform; and a glue spraying assembly arranged between the feeding mechanism and the assembly platform, wherein the glue spraying assembly comprises a glue gun and an annular component, the glue gun is connected to the annular component and is configured to reciprocate in a first direction and to spray glue to the bed mesh or the spring string.

### CROSS-REFERENCE TO RELATED APPLICATION

This application is based on and claims the benefit of priority from Chinese Patent Application No. 202510588410.0, filed on May 8, 2025, the entirety of which is incorporated by reference herein.

### TECHNICAL FIELD

The present disclosure relates to the technical field of bed mesh production devices, and more particularly, to a bed mesh bonding device and a bed mesh bonding method.

### BACKGROUND

A bed mesh bonding device is configured for sequentially bonding a plurality of spring strings to form a bed mesh. Typically, the bed mesh bonding device is required to be provided with a loading assembly that lays the spring strings in place. The bed mesh bonding device is further provided with a glue spraying assembly to spray glue to the spring strings, enabling the spring strings to bond together after glue spraying.

In the related arts, the bed mesh bonding device often has a complex structure. For example, a position where the glue spraying assembly is arranged needs a reversible avoidance device. When loading (laying the spring string), the avoidance device blocks the glue spraying assembly out of a loading space to avoid interference between the glue spraying assembly and the loading assembly (or the spring strings). After loading, the avoidance device allows the glue spraying assembly to move toward the spring strings to spray glue on a surface of the spring strings. This glue spraying method will cause problems of complicated glue spraying operation and complicated device structure.

### SUMMARY

In order to solve at least one of the technical problems above, the present disclosure provides a bed mesh bonding device and a bed mesh bonding method, which can simplify the structure of a glue spraying assembly. The present disclosure adopts the technical solutions as follows.

In a first aspect, an embodiment of the present disclosure provides a bed mesh bonding device, including:
a feeding mechanism configured for providing a spring string;
an assembly platform arranged at a first side of the feeding mechanism in a second direction, wherein the assembly platform is configured for bearing a bonded bed mesh;
a pushing mechanism arranged at a second side of the feeding mechanism in the second direction, wherein the pushing mechanism is configured for pushing the spring string from the feeding mechanism to the assembly platform; and
a glue spraying assembly arranged between the feeding mechanism and the assembly platform, wherein the glue spraying assembly includes a glue gun and an annular component, the glue gun is connected to the annular component and is configured to reciprocate in a first direction and to spray glue to the bed mesh or the spring string, the annular component is configured to move synchronously with the glue gun and includes at least one straight segment, and the straight segment is configured to bridge the feeding mechanism and the assembly platform during movement of the glue gun, so as to smoothly transfer the spring string from the feeding mechanism to the assembly platform.

In some embodiments of the present disclosure, the feeding mechanism includes two first conveying parts arranged in a third direction, the two first conveying parts are configured for clamping the spring string and conveying the spring string in the first direction, the two first conveying parts define a first feeding channel, and an interval between the first conveying parts is adjustable; and
the assembly platform includes two third conveying parts arranged in the third direction, the two third conveying parts are configured for clamping the bed mesh and conveying the bed mesh in the second direction, the two third conveying parts define a bed mesh channel, and the bed mesh channel is communicated with the first feeding channel in the second direction.

In some embodiments of the present disclosure, a bridging channel is arranged in a gap between the bed mesh channel and the first feeding channel, the straight segment of the annular component is arranged on one side of the bridging channel in the third direction, and a transition plate is arranged on another side of the bridging channel.

In some embodiments of the present disclosure, the glue spraying assembly further includes a first driving component, the first driving component is configured for driving the glue gun to reciprocate and simultaneously driving the annular component to move, and when the glue gun moves to any end of the assembly platform in the first direction, the annular component fills a gap between the feeding mechanism and the assembly platform in the first direction.

In some embodiments of the present disclosure, the annular component is provided with a notch, the glue gun is arranged on the notch of the annular component, and the annular component is movable in a circumferential direction to keep synchronization with movement of the glue gun in the first direction.

In some embodiments of the present disclosure, an annular plane enclosed by the annular component is perpendicular to the second direction.

In some embodiments of the present disclosure, the annular component includes at least one of a chain plate, a conveyor chain or a conveyor belt.

In some embodiments of the present disclosure, the feeding mechanism further includes two second conveying parts arranged in the third direction, the second conveying parts are configured for clamping the spring string along an axial direction of the spring string, the two second conveying parts defines a second feeding channel, the second conveying parts are arranged upstream of the first conveying parts in the first direction, the second feeding channel is communicated with the first feeding channel, and a conveying speed difference between the second conveying parts and the first conveying parts is adjustable to adjust an interval between adjacent springs in the spring string.

In some embodiments of the present disclosure, the feeding mechanism further includes a first transmission part and a second transmission part, the first transmission part is configured to drive the two first conveying parts to convey synchronously, and the second transmission part is configured to drive the two second conveying parts to convey synchronously.

In some embodiments of the present disclosure, the assembly platform includes a second driving component, and a bearing module and a movable module arranged at an interval in the third direction, the bed mesh channel is formed between the bearing module and the movable module, the bed mesh channel is configured for conveying the bed mesh in the second direction, and the driving component is configured to drive the movable module to move in the third direction to adjust a height of the bed mesh channel; and
one of the first conveying parts and one of the second conveying parts located on a same side as the movable module in the third direction are connected to the movable module and follow the movable module to move in the third direction.

In some embodiments of the present disclosure, one of the third conveying parts is arranged on the movable module, the movable module further includes a first roller and a first cutter, the third conveying part arranged on the movable module is configured for winding a top surface fabric and clamping a top part of the bed mesh, the first roller is arranged downstream of the third conveying part in a conveying direction, the first cutter is arranged between the third conveying part and the first roller, and the first roller is configured for driving the first cutter to move in the first direction to cut off the top surface fabric of the bed mesh.

In some embodiments of the present disclosure, another of the third conveying parts is arranged on the bearing module, the bearing module further includes a second roller and a second cutter, the third conveying part arranged on the bearing module is configured for winding a bottom surface fabric, the second roller is correspondingly arranged below the first roller in the third direction, the second cutter is correspondingly arranged below the first roller in the third direction, and the second roller is configured for driving the second cutter to move in the first direction to cut off the bottom surface fabric of the bed mesh.

In some embodiments of the present disclosure, the second driving component includes a first power mechanism and a plurality of screw stems extending in the third direction, the movable module is movably connected to the screw stems, and the first power mechanism is configured for driving the screw stems to rotate to drive the movable module to move in the third direction.

In some embodiments of the present disclosure, the bed mesh bonding device further includes a feeding device, the feeding device is arranged upstream of the feeding mechanism in a conveying direction of the spring string, the feeding device includes a welding and cutting mechanism, a loading mechanism and a bridging assembly, the loading mechanism includes a plurality of loading assemblies, the loading assemblies are configured for respective spring strings to pass through, any one of the loading assemblies is movable to be aligned with a loading position, and the loading position is communicated with an inlet of the feeding mechanism.

In some embodiments of the present disclosure, the loading mechanism includes a supporting plate and a third driving component, a sliding chute is arranged on the supporting plate, the plurality of loading assemblies are slidably arranged in the sliding chute, the sliding chute is provided with a bending segment which protrudes towards the loading position, the third driving component is arranged at one side of the sliding chute away from the feeding mechanism, a driving direction of the third driving component is identical to an extending direction of the sliding chute, the third driving component is configured to drive any of the loading assemblies to slide to the bending segment, such that the respective loading assembly located at the bending segment is arranged to be aligned with the loading position.

In some embodiments of the present disclosure, the loading mechanism further includes a plurality of pressing plates, each of the pressing plates is arranged at a top part of a respective one of the loading assemblies, each of the pressing plates is movable in the third direction and configured for abutting against a top part of the respective spring string.

In some embodiments of the present disclosure, the welding and cutting mechanism is arranged between the feeding mechanism and the loading mechanism, and is configured for cutting a continuous spring string into preset lengths, the welding and cutting mechanism includes a third cutter, and an ultrasonic welding head and a welding blade which are arranged in pair, the ultrasonic welding head and the welding blade are movable away from each other for the spring string to pass through, surfaces of the welding blade and the ultrasonic welding head which are in contact with each other are provided with a cutting groove through which the third cutter passes, and when the ultrasonic welding head and the welding blade approach each other, the third cutter is able to pass through the groove and cut off the spring string.

In some embodiments of the present disclosure, the welding and cutting mechanism further includes a fixing frame, and a fourth driving component and an installing member arranged on the fixing frame, the welding blade is fixedly arranged on the fixing frame, the ultrasonic welding head is slidably arranged on the fixing frame through the installing member, and the fourth driving component is configured for driving the ultrasonic welding head to move toward or away from the welding blade; and
the ultrasonic welding head is elastically connected to the installing member through an elastic part, and the elastic part serves as a buffer when the ultrasonic welding head presses against the welding blade.

In some embodiments of the present disclosure, the bridging assembly is arranged on one side of the welding and cutting mechanism facing the feeding mechanism, the bridging assembly includes a fifth driving component and a pair of clamping plates, the fifth driving component is configured for driving the clamping plates to reciprocate between the feeding mechanism and the welding and cutting mechanism in the first direction, the clamping plates are capable of passing through the welding and cutting mechanism and are configured for clamping the spring string at the loading position, pulling the spring string and feeding the spring string to the feeding mechanism.

In some embodiments of the present disclosure, the bed mesh bonding device further includes a fabric feeding mechanism arranged on one side of the assembly platform away from a bed mesh channel, the fabric feeding mechanism includes two material racks and two press rollers, the material racks are configured for supporting fabric rolls of a top surface fabric and a bottom surface fabric of the bed mesh, the assembly platform includes two third conveying parts arranged at an interval in a third direction, the bed mesh channel is formed between the two third conveying parts, one of the third conveying parts and one of the press rollers are configured for winding the top surface fabric, another of the third conveying parts and another of the press rollers are configured for winding the bottom surface fabric, the two press rollers are configured respectively for exerting a pressing force on the two third conveying parts towards the bed mesh channel, such that the two third conveying parts are capable of conveying the top surface fabric and the bottom surface fabric in the second direction.

In some embodiments of the present disclosure, the bed mesh bonding device further includes fabric receiving mechanisms, each of the fabric receiving mechanisms is arranged between the respective fabric roll and the respective press roller, and includes two cross beams arranged at an interval in the third direction, a heating structure is arranged on one of the cross beams, the two cross beams are movable towards each other to press against the surface fabric, and the heating mechanism is configured for thermally welding the two surface fabrics.

In a second aspect, an embodiment of the present disclosure provides a bed mesh bonding method, including:
providing, by a feeding mechanism, a spring string in a first direction;
spraying, by a glue gun moving in the first direction, glue on at least one of the spring string located in the feeding mechanism or a bed mesh located in an assembly platform; wherein an annular component moves synchronously with the glue gun, and a straight segment of the annular component bridges the feeding mechanism and the assembly platform; and
pushing, by a pushing mechanism, the spring string in a second direction, such that the spring string reaches the assembly platform from the feeding mechanism through the straight segment, and the spring string and the bed mesh are bonded with each other.

The embodiments of the present disclosure at least have the following beneficial effects. By setting the annular component to be movable synchronously with the glue gun, on one hand, after the glue gun moves in the first direction and sprays glue on the spring string or the bed mesh, the glue gun is located at one side of the spring string in the first direction, preventing the glue gun from blocking the spring string from pushing. Meanwhile, the annular component moves synchronously with the glue gun, and the straight segment of the annular component constitutes a part of a moving path of the spring string. Therefore, the annular component will not interfere with the glue gun, the spring string and the feeding mechanism, which solves a problem of mutual interference between the glue spraying assembly and the feeding mechanism. Therefore, there is no need to additionally arrange an avoidance structure or avoidance action for the glue spraying assembly, thus simplifying a structural design of the glue spraying assembly. On the other hand, the annular component can fill the gap between the feeding mechanism and the assembly platform, thus eliminating other mechanisms to fill the gap between the feeding mechanism and the assembly platform. This further simplifies the structure of the glue spraying assembly, thereby saving a quantity of parts of the bed mesh bonding device, simplifying the structure of the bed mesh bonding device and making the whole structure more compact. In this process, the annular component enables the spring string to be smoothly transferred from the feeding mechanism to the assembly platform, and improves stability of the spring string during moving.

### BRIEF DESCRIPTION OF THE DRAWINGS

The present disclosure will be further described in detail below with reference to the accompanying drawings and specific embodiments. It should be noted that the embodiments described below with reference to the accompanying drawings are exemplary and are only intended to explain the present disclosure, but should not be construed as limiting the present disclosure.

FIG. 1 is a schematic structural diagram of a bed mesh bonding device provided by embodiments of the present disclosure;

FIG. 2 is a schematic structural diagram of a feeding mechanism of the bed mesh bonding device provided by the embodiments of the present disclosure;

FIG. 3 is a schematic structural diagram of a glue spraying assembly of the bed mesh bonding device provided by the embodiments of the present disclosure;

FIG. 4 is a side view of the bed mesh bonding device provided by the embodiments of the present disclosure in a state of hiding a fabric feeding mechanism;

FIG. 5 is a side view of the bed mesh bonding device provided by the embodiments of the present disclosure;

FIG. 6 is a schematic diagram of a connection between a feeding device and the feeding mechanism of the bed mesh bonding device provided by the embodiments of the present disclosure;

FIG. 7 is a front view of a welding and cutting mechanism of the bed mesh bonding device provided by the embodiments of the present disclosure;

FIG. 8 is a three-dimensional schematic diagram of the welding and cutting mechanism of the bed mesh bonding device provided by the embodiments of the present disclosure;

FIG. 9 is a schematic diagram of a loading mechanism of the bed mesh bonding device provided by the embodiments of the present disclosure;

FIG. 10 is a side view of the loading mechanism of the bed mesh bonding device provided by the embodiments of the present disclosure; and

FIG. 11 is a flow chart of a bed mesh bonding method provided by the present disclosure.

Reference numerals: 1000—bed mesh bonding device;

100—feeding mechanism; 110—first conveying part; 111—first feeding channel; 120—second conveying part; 121—second feeding channel; 130—first transmission part; 14—second transmission part;

200—assembly platform; 210—third conveying part; 211—bed mesh channel; 220—second driving component; 221—screw stem; 222—first power mechanism; 223—transmission structure; 230—bearing module; 231—second roller; 232—second cutter; 240—movable module; 241—first roller; 242—first cutter;

300—pushing mechanism; 310—pushing rod;

400—glue spraying assembly; 410—glue gun; 411—sprayer; 420—annular component; 421—straight segment; 422—notch; 430—bridging channel; 431—transition plate; 440—first driving component; 450—steering roller;

500—feeding device; 510—welding and cutting mechanism; 511—third cutter; 512—ultrasonic welding head; 5121—cutting groove; 513—welding blade; 514—fixing frame; 515—fourth driving component; 5151—swiveling structure; 5152—second connecting rod; 5153—installing plate; 516—installing member; 5161—guide rail; 5162—first connecting rod; 517—elastic part; 520—loading mechanism; 521—loading assembly; 522—supporting plate; 5221—sliding chute; 5222—bending segment; 523—third driving component; 5231—power mechanism; 5232—conveyor belt; 524 pressing plate; 525—roller; 530—bridging assembly; 531—fifth driving component; 532—clamping plate;

600—fabric feeding mechanism; 610—material rack; 620—press roller;

700—fabric receiving mechanism; 710—cross beam; 720—heating structure; and

2000—spring string; 2100—bed mesh; 3000—fabric roll; 3100—top surface fabric; and 3200—bottom surface fabric.

### DETAILED DESCRIPTION OF THE EMBODIMENTS

The embodiments of the present disclosure will be described in detail hereinafter with reference to the drawings, and the same or similar reference numerals throughout the drawings denote the same or similar elements or elements having the same or similar functions. The embodiments described hereinafter with reference to the drawings are exemplary, are only intended to explain the present disclosure, and cannot be understood as limiting the present disclosure.

In the description of the present disclosure, it should be understood that, the orientation or position relationship related to the orientation description, such as the orientation or position relationship indicated by the terms such as “center”, “middle”, “longitudinal”, “transversal”, “length”, “width”, “thickness”, “up”, “down”, “front”, “back”, “left”, “right”, “vertical”, “horizontal”, “top”, “bottom”, “inside”, “outside”, “axial”, “radical”, “circumferential” is based on the orientation or position relationship shown in the drawings, which is only configured for convenience of the description of the present disclosure and simplification of the description instead of indicating or implying that the indicated device or element must have a specific orientation, and be constructed and operated in a specific orientation, and thus should not be understood as a limitation to the present disclosure.

In the description of the present disclosure, the term “several” refers to being one or more, the term “a plurality of” refers to being two or more, and the terms such as “greater than”, “less than”, “more than” are understood as not including the specified number, while the terms such as “above”, “below”, “within” are understood as including the specified number. If there is a description to the first and second, it is only for the purpose of distinguishing between technical features, and shall not be understood as indicating or implying relative importance, implicitly indicating the number of the indicated technical features or implicitly indicating the order of the indicated technical features.

In the description of the present disclosure, unless expressly stipulated and defined otherwise, terms such as “arrangement”, “installation”, “connected” and “connection” should be understood broadly, for example, may either be fixed connection or detachable connection, and may also be integral connection; may also be mechanical connection or electrical connection; and may be direct connection, may also be indirect connection through an intermediate medium, and may be communication inside two elements. The specific meaning of the above terms in the present disclosure can be understood in a specific case by those of ordinary skills in the art.

In the description of the present disclosure, the descriptions with reference to the terms such as “an embodiment”, “one embodiment”, “some examples”, “some embodiments”, “illustrative embodiments”, “examples”, “specific examples” or “several examples” mean that the specific features, structures, materials or characteristics described in connection with this embodiment or example are included in at least one embodiment or example of the present disclosure. In this specification, the schematic representation of the above terms does not necessarily refer to the same embodiment or example. Moreover, the specific features, structures, materials or characteristics described may be combined in any one or more embodiments or examples in a suitable manner. In this specification, the schematic representation of the above terms does not necessarily refer to the same embodiment or example. Moreover, the specific features, structures, materials or characteristics described may be combined in any one or more embodiments or examples in a suitable manner.

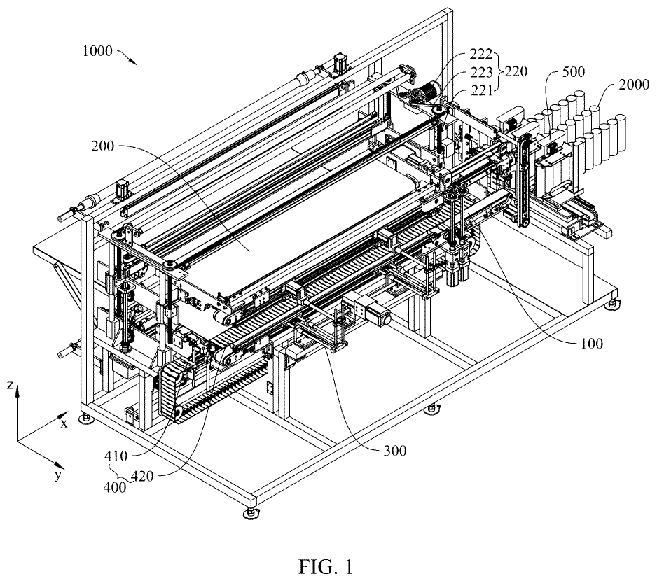

Referring to FIG. 1 to FIG. 4, in a first aspect, an embodiment of the present disclosure provides a bed mesh bonding device 1000, including a feeding mechanism 100, an assembly platform 200, a pushing mechanism 300 and a glue spraying assembly 400. The feeding mechanism 100 is configured for providing a spring string 2000, the assembly platform 200 is arranged at a first side of the feeding mechanism 100 in a second direction (y direction shown in FIG. 1), and the assembly platform 200 is configured for bearing a bonded bed mesh 2100. The pushing mechanism 300 is arranged at a second side of the feeding mechanism 100 in the second direction, and the pushing mechanism 300 is configured for pushing the spring string 2000 from the feeding mechanism 100 to the assembly platform 200. The glue spraying assembly 400 is arranged between the feeding mechanism 100 and the assembly platform 200, and the glue spraying assembly 400 includes a glue gun 410 and an annular component 420. The glue gun 410 is connected to the annular component 420. The glue gun 410 reciprocates in a first direction (x direction shown in FIG. 1) and is configured for spraying glue to the bed mesh 2100 or the spring string 2000. The annular component 420 moves synchronously with the glue gun 410, and the annular component 420 includes at least one straight segment 421. When the glue gun 410 moves, the straight segment 421 bridges a gap between the feeding mechanism 100 and the assembly platform 200, so that the spring string 2000 is smoothly transferred from the feeding mechanism 100 to the assembly platform 200.

In the present disclosure, by setting the annular component 420 and arranging the glue gun 410 on the annular component 420, the annular component 420 and the glue gun 410 can move synchronously, that is, when one of the annular component 420 or the glue gun 410 is driven, the other can move synchronously. On one hand, after the glue gun 410 moves in the first direction x and sprays glue on the spring string 2000 or the bed mesh 2100, the glue gun 410 is located at one side of the spring string 2000 in the first direction x to prevent the glue gun 410 from blocking the spring string 2000 from pushing. Meanwhile, the annular component 420 moves synchronously with the glue gun 410, and the straight segment 421 of the annular component 420 constitutes a part of a moving path of the spring string 2000. Therefore, the annular component 420 will not interfere with the glue gun 410, the spring string 2000 and the feeding mechanism 100, which solves a problem of mutual interference between the glue spraying assembly 400 and the feeding mechanism 100. Therefore, there is no need to additionally arrange an avoidance structure or avoidance action for the glue spraying assembly 400, thus simplifying a structural design of the glue spraying assembly 400. On the other hand, the annular component 420 can fill the gap between the feeding mechanism 100 and the assembly platform 200, and the straight segment 421 of the annular component 421 can form a part of a channel for the spring string 2000 to enter the assembly platform 200 from the feeding mechanism 100, thus eliminating other mechanisms to fill the gap between the feeding mechanism 100 and the assembly platform 200. This further simplifies the structure of the glue spraying assembly 400, thereby saving a quantity of parts of the bed mesh 2100 bonding device, simplifying the structure of the bed mesh 2100 bonding device and making the whole structure more compact. In this process, the annular component 420 enables the spring string 2000 to be smoothly transferred from the feeding mechanism 100 to the assembly platform 200, and improves stability of the spring string 2000 during moving. It is visible that providing the glue spraying assembly 400 with the annular component 420 can not only meet requirements of the glue spraying assembly 400 to avoid the spring string 2000 in the process of pushing the spring string 2000, but also achieve effects of filling the gap and improving movement stability of the spring string 2000.

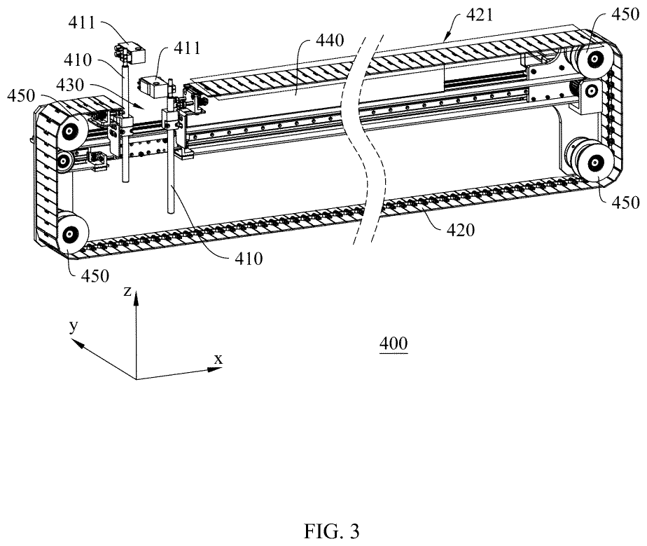

Referring to FIG. 3, it can be understood that a part of the annular component 420 forms the straight segment 421, and the part other than the straight segment 421 is arranged in an area outside the gap between the feeding mechanism 100 and the assembly platform 200. During a circumferential movement of the annular component 420, the straight segment 421 shows an effect of moving in the first direction x, so a moving path of the straight segment 421 is the same as that of the glue gun 410. With the closed-loop configuration of the annular component 420, when the glue gun 410 reciprocates along the first direction x (forward direction or backward direction of x axis shown in FIG. 3), there is always a part of the annular component 420 serving as the straight segment 421 to bridge the gap between the feeding mechanism 100 and the assembly platform 200. Therefore, when the glue gun 410 moves to any position in the first direction x, the gap between the feeding mechanism 100 and the assembly platform 200 is always filled with a straight segment 421. In this way, it can be ensured that the spring string 2000 is smoothly transferred from the feeding mechanism 100 to the assembly platform 200.

In some embodiments, the annular component 420 is provided with a notch 422, the glue gun 410 is arranged on the notch 422 of the annular component 420, and the annular component 420 moves in a circumferential direction to keep synchronization with movement of the glue gun 410 in the first direction x. By setting the notch 422 in the annular component 420, the glue gun 410 can be arranged on the notch 422, so as to avoid the glue gun 410 and the annular component 420 from interfering with each other.

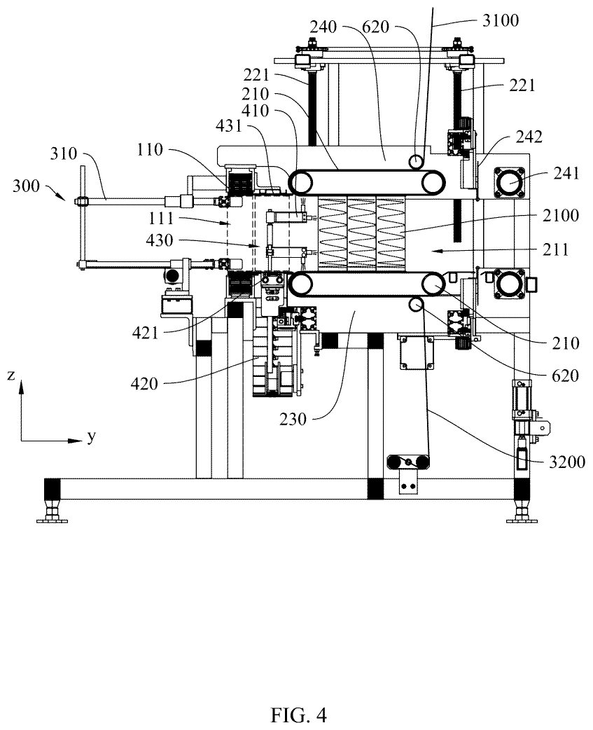

Optionally, the glue gun 410 may be provided with a plurality of sprayers 411. In some examples, as shown in FIG. 4, the plurality of sprayers 411 are arranged opposite each other along the second direction y, wherein one of the sprayers 411 is configured for spraying glue to the bed mesh 2100 located in the assembly platform 200, and the other of the sprayers 411 is configured for spraying glue to the spring string 2000 located in the feeding mechanism 100. The glue gun 410 moves from one end to the other end of the spring string 2000 in the first direction x, so that the spring string 2000 and the bed mesh 2100 can be sprayed with glue at the same time, which facilitates bonding of the spring string 2000 to the bed mesh 2100. Of course, in other examples, the sprayers 411 may also be set on one side, that is, it is only used to spray glue to one of the spring string 2000 or the bed mesh 2100. In other examples, the plurality of sprayers 411 may be arranged along a third direction z, an axial direction of the spring is parallel to the third direction z, and the plurality of sprayers 411 spray glue at the same time, so that multi-point glue spraying can be carried out in the axial direction of the spring to improve a glue spraying efficiency and a glue spraying effect.

For example, referring to FIG. 4, the pushing mechanism 300 may include a pushing rod 310, a pushing plate and other structures. The pushing rod 310 may be composed of an output end of a structure such as a motor and a cylinder, or a rod member is connected to an output end of a motor, and the spring string 2000 is pushed from the feeding mechanism 100 to the assembly platform 200 by the expansion and contraction of the pushing rod 310 in the second direction y, so as to realize mutual bonding between the spring string 2000 and the bed mesh 2100. The pushing plate may be arranged at one end of the pushing rod 310 for contacting with the spring string 2000, and the pushing plate may be arranged extending along the first direction x, so that a contact area between the pushing rod 310 and the spring string 2000 can be increased, and the spring string 2000 can move more smoothly during pushing. The pushing rod 310 may also provide a supporting force for the bonding of the spring string 2000 and the bed mesh 2100, that is, when the spring string 2000 contacts the bed mesh 2100, the pushing rod 310 applies a pressing force to the spring string 2000 in the second direction y, so that the spring string 2000 and the bed mesh 2100 are better bonded under the action of the pressing force.

In some embodiments, the glue spraying assembly 400 further includes a first driving component 440, and the first driving component 440 is configured for driving the glue gun 410 to reciprocate and simultaneously driving the annular component 420 to move. When the glue gun 410 moves to any end of the assembly platform 200 in the first direction x, the annular component 420 fills the gap between the feeding mechanism 100 and the assembly platform 200 in the first direction x. With a driving action of the first driving component 440, the movement of the annular component 420 and the glue gun 410 can be realized, so that the glue gun 410 can spray glue on the spring string 2000 and the bed mesh 2100, and the annular component 420 can serve to bridge the gap between the feeding mechanism 100 and the assembly platform 200. By using the annular component 420 to fill the gap in the first direction x, it can be ensured that any spring in the spring string 2000 can be supported by the annular component 420 in the process of moving from the feeding mechanism 100 to the assembly platform 200, so as to avoid the spring from being stuck in the gap between the feeding mechanism 100 and the assembly platform 200, and further improve reliability of a pushing process of the spring string 2000.

Illustratively, the first driving component 440 may be a motor, a cylinder, or the like. Taking the motor as an example, power of the motor is output to the annular component 420, and the annular component 420 can drive the glue gun 410 to move in the first direction x while the annular component 420 is driven to move in the circumferential direction, or the power of the motor is output to the glue gun 410, and the glue gun 410 drives the annular component 420 to move in the circumferential direction while the glue gun 410 is driven to move. Optionally, in order to improve stability of the annular component 420 during movement, the glue spraying assembly 400 may also be provided with a guide rail 5161 to guide movement of the annular component 420. An output end of the motor may be directly connected with the annular component 420 or the glue gun 410, or may also indirectly drive the annular component 420 or the glue gun 410 to move through other transmission parts such as a belt.

In some embodiments, an annular plane enclosed by the annular component 420 is perpendicular to the second direction y. In this way, a part of the annular component 420 except the straight segment 421 can be accommodated in a space between the feeding mechanism 100 and the assembly platform 200, making a structure of the whole bed mesh bonding device 1000 more compact. Of course, in other examples, the annular plane enclosed by the annular component 420 may also be perpendicular to the third direction z.

In some embodiments, the annular component 420 includes at least one of a chain plate, a conveyor chain and a conveyor belt. Taking FIG. 3 as an example, the annular component 420 is formed by sequentially splicing a plurality of chain plates along the circumferential direction, and the plurality of chain plates are engaged with each other to form a continuous chain structure. Two adjacent chain plates can rotate with each other, and the two adjacent chain plates can be coplanar to form the straight segment 421. A certain angle may be formed between the two adjacent chain plates to form an annular structure. Each chain plate has a certain bearing area, so the chain plates can form the straight segment 421 with a certain width after being connected with each other, and the gap between the feeding mechanism 100 and the assembly platform 200 can be bridged. Of course, in other examples, the annular component 420 may also be a structure such as a conveyor chain, a conveyor belt (for example, a belt), or a combination of any two or more of a chain plate, a conveyor chain and a conveyor belt.

Optionally, in order to realize smooth circumferential movement of the annular component 420, the glue spraying assembly 400 may further include a plurality of steering rollers 450. The steering rollers 450 are at least arranged at an inner side of the annular component 420. The steering rollers 450 are configured for supporting the annular component 420 and providing a tension for the annular component 420, so that the annular component 420 can be supported to form an annular plane. The annular component 420 can perform smooth circumferential movement under the support of the steering rollers 450. Optionally, one of the steering rollers 450 may also be used as the first driving component 440 to provide power for annular movement of the annular component 420. For example, a rotating motor is used to drive one of the steering rollers 450, and the annular component 420 is driven to rotate in the annular direction by the rotation of the steering roller 450, so that the glue gun 410 moves with the annular component 420.

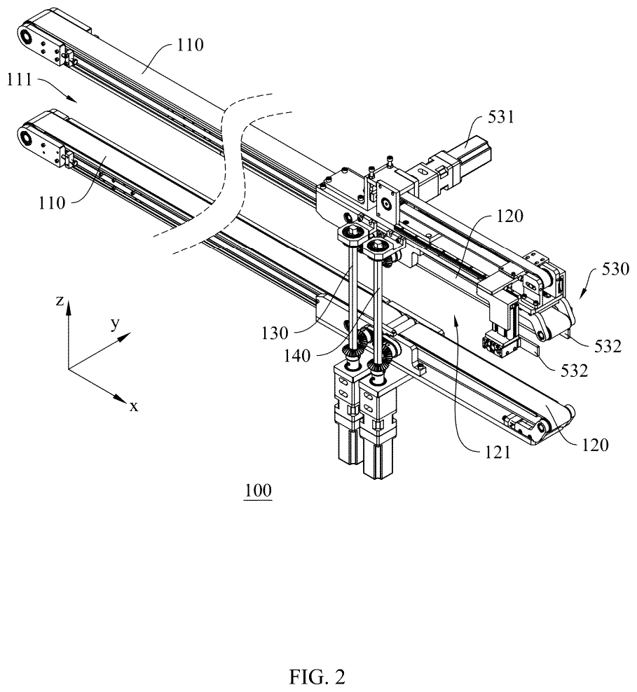

In some embodiments, referring to FIG. 2, the feeding mechanism 100 includes two first conveying parts 110 arranged in the third direction z. The two first conveying parts 110 are configured for clamping the spring string 2000 and conveying the spring string 2000 in the first direction x, the two first conveying parts 110 form a first feeding channel 111, and an interval between the first conveying parts 110 is adjustable. The assembly platform 200 includes two third conveying parts 210 arranged in the third direction z. The two third conveying parts 210 are configured for clamping the bed mesh 2100 and conveying the bed mesh 2100 in the second direction y, the two third conveying parts 210 form a bed mesh channel 211, and the bed mesh channel 211 is communicated with the first feeding channel 111 in the second direction y. Using the pair of first conveying parts 110 to clamp the spring string 2000 in the third direction z can stabilize the spring string 2000 in the axial direction of the spring and prevent the spring string 2000 from bouncing during conveying. Similarly, the two third conveying parts 210 arranged in the third direction Z can also stabilize the bed mesh 2100 and the spring string 2000 bonded to the bed mesh 2100. The bed mesh channel 211 is communicated with the first feeding channel 111 in the second direction y, so that the spring string 2000 can be pushed into the bed mesh channel 211 by the pushing mechanism 300 from the first feeding channel 111 in the second direction y and bonded with the bed mesh 2100 located in the bed mesh channel 211. The spring string 2000 is arranged and loaded along the first direction x and bonded to the bed mesh 2100 along the second direction y. By adopting this arrangement, loading and bonding actions of the spring string 2000 do not interfere with each other, and independence and operational reliability of the loading and bonding processes of the spring string 2000 can be improved.

In some embodiments, with reference to FIG. 4, a bridging channel 430 is arranged in a gap between the bed mesh channel 211 and the first feeding channel 111, the straight segment 421 of the annular component 420 is arranged on one side of the bridging channel 430 in the third direction z, and a transition plate 431 is arranged on another side of the bridging channel. The gap between the bed mesh channel 211 and the first feeding channel 111 is filled with the bridging channel 430, which can ensure the smooth transition of the spring string into the bed mesh channel 211 from the first feeding channel 111. One side of the bridging channel 430 is composed of the straight segment 421 of the annular component 420, which can save a space occupied by the glue spraying assembly 400. Another side of the bridging channel 430 is provided with a transition plate 431, which can clamp the spring string 2000 cooperatively with the straight segment 421 of the annular component 420 in the third direction z, so as to avoid the spring string 2000 from bouncing or deforming during the pushing movement and improve the stability of the spring string 2000 during the moving process.

Optionally, taking FIG. 4 as an example, the third direction z may be a vertical direction, that is, the straight segment 421 of the annular component 420 and the transition plate 431 are vertically distributed. In the example of FIG. 4, the transition plate 431 is arranged above the annular component 420. Of course, in other examples, the third direction z may not be limited to the vertical direction, and the third direction z may also be a horizontal direction.

In some embodiments, please refer to FIG. 2 again. The feeding mechanism 100 further includes two second conveying parts 120 arranged in the third direction z. The second conveying parts 120 are configured for clamping the spring string 2000 along an axial direction of the spring string 2000. The two second conveying parts 120 form a second feeding channel 121, the second conveying parts 120 are arranged upstream of the first conveying parts 110 in the first direction x, the second feeding channel 121 is communicated with the first feeding channel 111, and a conveying speed difference between the second conveying parts 120 and the first conveying parts 110 is adjustable to adjust an interval between adjacent springs in the spring string 2000. Since the spring string 2000 is formed by wrapping a plurality of springs individually with fabric, that is, adjacent springs in the spring string 2000 are connected by fabric, the two adjacent springs can move relative to each other. Therefore, by using the conveying speed difference between the second conveying parts 120 and the first conveying parts 110, the interval between two adjacent springs (that is, an interval between adjacent springs in the first direction x) can be adjusted, and the spring string 2000 can be adjusted to a target interval when loading, and then the spring string 2000 is pushed to the assembly platform 200 from the first feeding channel 111. In this case, the spring string 2000 can be directly bonded to the bed mesh 2100 without adjusting the interval of the springs again, thus improving an operation efficiency of bonding the bed mesh 2100.

In some embodiments, the feeding mechanism 100 further includes a first transmission part 130 and a second transmission part 140. The first transmission part 130 drives the two first conveying parts 110 to convey synchronously, and the second transmission part 140 drives the two second conveying parts 120 to convey synchronously. The synchronous movement of the two first conveying parts 110 can be realized by using the first transmission part 130, which ensures that the spring string 2000 can be transported smoothly in a first conveying channel. Similarly, the second transmission part 140 can realize the synchronous movement of the two second conveying parts 120, ensuring that the spring string 2000 can be transported smoothly in a second conveying channel.

For example, the first transmission part 130 may be a transmission rod, and transmission gears are respectively arranged at both ends of the transmission rod. The two first conveying parts 110 are respectively driven by the two transmission gears. The implementation of the second transmission part 140 can refer to the first transmission part 130. It can be understood that a transmission speed of the second transmission part 140 may be set to be different from that of the first transmission part 130, so that a speed difference can be formed between the first transmission part 110 and the second transmission part 120, and the adjacent springs of the spring string can move toward each other in the conveying process.

Exemplarily, the first conveying parts 110 and the second conveying parts 120 may be conveyor belts, conveyor chains and other structures.

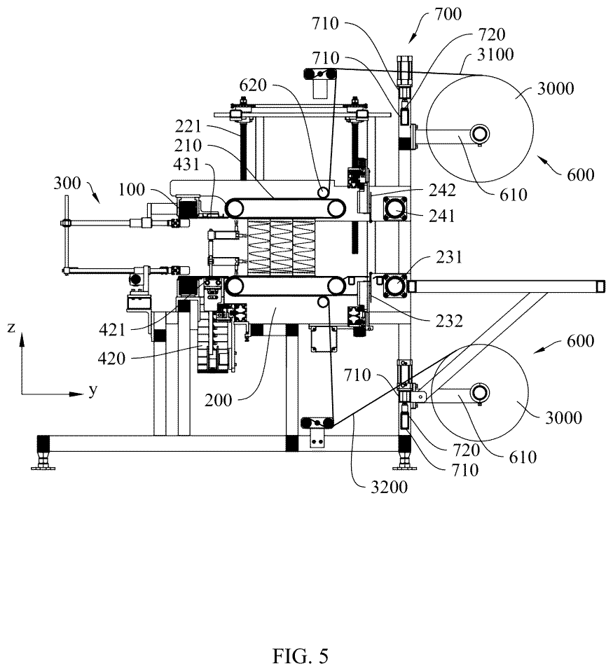

In some embodiments, please refer to FIG. 4 and FIG. 5. The assembly platform 200 includes a second driving component 220, and a bearing module 230 and a movable module 240 arranged at an interval in the third direction z. The bed mesh channel 211 is formed between the bearing module 230 and the movable module 240. The bed mesh channel 211 is configured for conveying the bed mesh 2100 in the second direction y, and the second driving component 220 drives the movable module 240 to move in the third direction z to adjust a height of the bed mesh channel 211. The first conveying part 110 and the second conveying part 120 located on the same side as the movable module 240 in the third direction z are connected to the movable module 240 and are movable along the third direction z with the movable module 240. By moving the movable module 240 relative to the bearing module 230, the height of the bed mesh channel 211 can be adjusted to adapt to the spring strings 2000 with different heights. Both the bearing module 230 and the movable module 240 can clamp the bed mesh 2100 to prevent the spring strings 2000 that make up the bed mesh 2100 from bouncing or deforming. In this way, the spring string 2000 can always be held at both ends in the axial direction in processes of loading the spring string 2000, pushing the spring string 2000 into the bed mesh channel 211 and bonding the spring string 2000 in the bed mesh channel 211. When adjusting the movable module 240, the movable module 240 drives the first conveying part 110 and the second conveying part 120 at the same side to move at the same time, so that heights of the first conveying channel and the second conveying channel and the height of the bed mesh channel 211 can be adjusted synchronously. This reduces the number of adjusting structures, simplifies the adjusting operation, and improves the efficiency of the adjusting operation.

In some embodiments, one of the third conveying parts 210 is arranged on the movable module 240. The movable module 240 further includes a first roller 241 and a first cutter 242. The third conveying part 210 arranged on the movable module 240 is configured for winding a top surface fabric 3100 and clamping a top part of the bed mesh 2100, the first roller 241 is arranged downstream of the third conveying part 210 in a conveying direction, the first cutter 242 is arranged between the third conveying part 210 and the first roller 241, and the first roller 241 is configured for driving the first cutter 242 to move in the first direction to cut off the top surface fabric 3100 of the bed mesh 2100. The top surface fabric 3100 is wound by the third conveying part 210, and a conveying action of the third conveying part 210 in the second direction y can drive the top surface fabric 3100 to move synchronously and be bonded to the top part of the bed mesh 2100. In this way, when the spring string 2000 is bonded in the second direction y to form the bed mesh 2100, the top surface fabric 3100 can also be transported and bonded in the second direction y synchronously, so as to achieve an effect of a synchronous bonding operation between the top surface fabric 3100 and the bed mesh 2100. When the bed mesh 2100 is bonded, the first roller 241 drives the first cutter 242 to move, and the first cutter 242 can cut the top surface fabric 3100, so as to control a laying length of the top surface fabric 3100 to match a size of the bed mesh 2100.

In some embodiments, another of the third conveying parts 210 is arranged on the bearing module 230. The bearing module 230 further includes a second roller 231 and a second cutter 232. The third conveying part 210 arranged on the bearing module 230 is configured for winding a bottom surface fabric 3200, the second roller 231 is correspondingly arranged below the first roller 241 in the third direction z, the second cutter 232 is correspondingly arranged below the first roller 242 in the third direction z, and the second roller 231 drives the second cutter 232 to move in the first direction x to cut off the bottom surface fabric 3200 of the bed mesh 2100. The bottom surface fabric 3200 is wound by the third conveying part 210, and the conveying action of the third conveying part 210 in the second direction y can drive the bottom surface fabric 3200 to move synchronously and be bonded to the bottom part of the bed mesh 2100. In this way, when the spring string 2000 is bonded in the second direction y to form the bed mesh 2100, the bottom surface fabric 3200 can also be transported and bonded in the second direction y synchronously, so as to achieve an effect of a synchronous bonding operation between the bottom surface fabric 3200 and the bed mesh 2100. When the bed mesh 2100 is bonded, the second roller 231 drives the second cutter 232 to move, and the second cutter 232 can cut the bottom surface fabric 3200, so as to control a laying length of the bottom surface fabric 3200 to match the size of the bed mesh 2100.

In some embodiments, please refer to FIG. 1 and FIG. 4. The second driving component 220 includes a first power mechanism 222 and a plurality of screw stems 221 extending in the third direction z. The movable module 240 is movably connected to the screw stems 221, and the first power mechanism 222 drives the screw stems 221 to rotate to drive the movable module 240 to move in the third direction z. Using the plurality of screw stems 221 to synchronously drive the movable module 240 to move can improve movement stability and movement accuracy of the movable module 240, thereby improving reliability of the height adjustment operation of the bed mesh channel 211. Optionally, four screw stems 221 may be arranged, and the four screw stems 221 are respectively arranged corresponding to four corners of the movable module 240, so that the movable module 240 is more balanced during moving. As an alternative solution, movement of the movable module 240 in the third direction may also be driven by a rack and pinion.

Optionally, the plurality of screw stems 221 may also be connected with each other through a transmission structure 223 (such as a chain, a belt, or the like), so as to ensure synchronization of rotation among the plurality of screw stems 221.

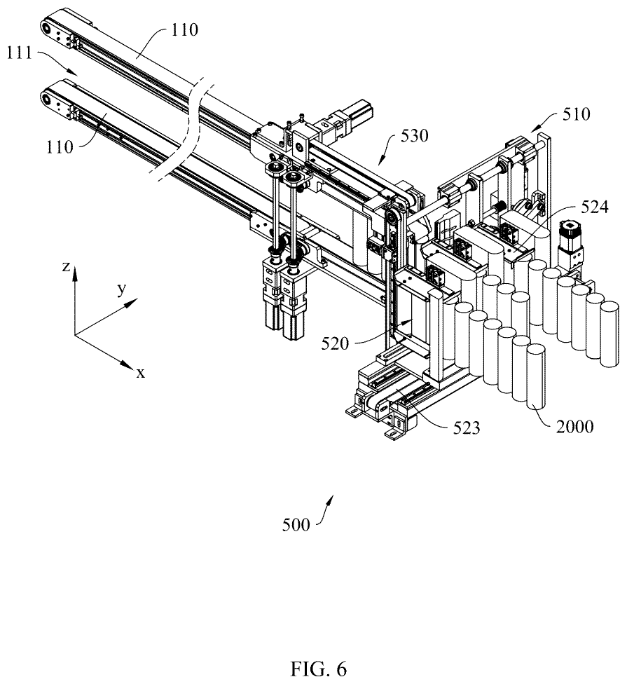

In some embodiments, please refer to FIG. 6 to FIG. 10. The bed mesh bonding device 1000 further includes a feeding device 500. The feeding device 500 is arranged upstream of the feeding mechanism 100 in a conveying direction of the spring string 2000. The feeding device 500 includes a welding and cutting mechanism 510, a loading mechanism 520 and a bridging assembly 530. The loading mechanism 520 includes a plurality of loading assemblies 521. The loading assemblies 521 are configured for the spring string 2000 to pass through, any one of the loading assemblies 521 is movable to be aligned with a loading position, and the loading position is communicated with an inlet of the feeding mechanism 100. By arranging the plurality of loading assemblies 521, when one of the loading assemblies 521 is aligned with the loading position, the remaining loading assemblies 521 are in an idle state, and then the spring strings 2000 can be supplemented to the remaining loading assemblies 521. When the loading assembly 521 at the loading position finishes loading, any one of the remaining loading assemblies 521 moves to a position aligned with the loading position and carries out loading. On one hand, this arrangement saves a waiting time for the loading assembly 521 to supplement the spring string 2000. On the other hand, each loading assembly 521 can be connected with one spring machine, that is, a plurality of spring machines can supply the spring strings 2000 to the same bed mesh bonding device 1000 at the same time, which can adapt to differences in production rhythm (i.e., cycle time differences) between the spring machines and the bed mesh bonding device 1000, i.e., it enables a speed at which the spring machine provides the spring string 2000 to be approximately the same as a speed at which the bed mesh bonding device 1000 consumes the spring string 2000, thereby reducing time waste in the production process of the bed mesh 2100.

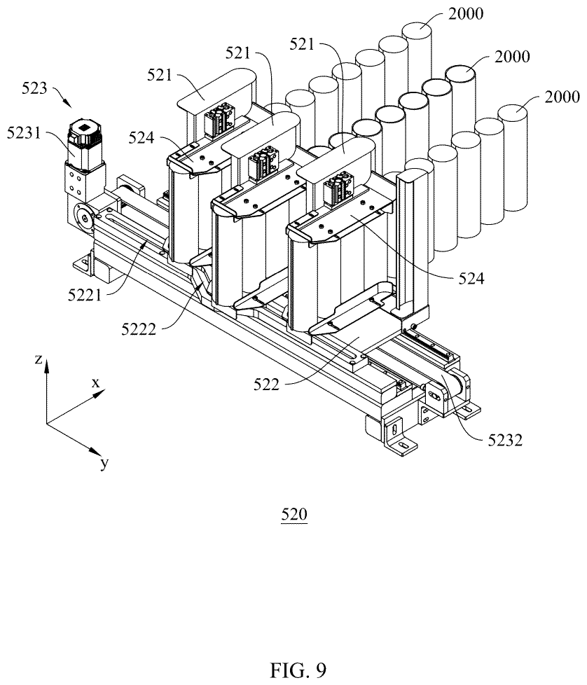

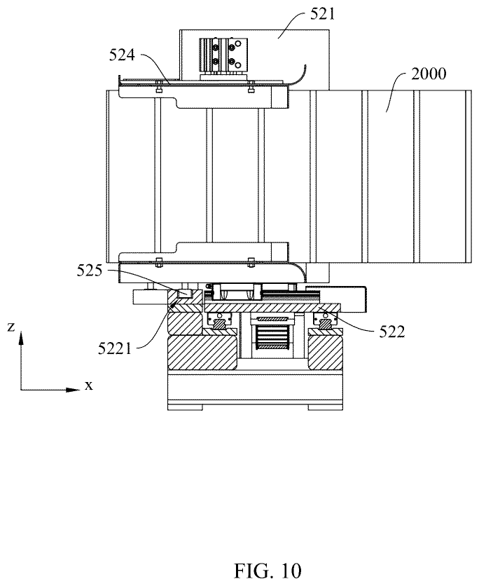

In some embodiments, please refer to FIG. 9 and FIG. 10, the loading mechanism 520 includes a supporting plate 522 and a third driving component 523. A sliding chute 5221 is arranged on the supporting plate 522, the plurality of loading assemblies 521 are slidably arranged in the sliding chute 5221, the sliding chute 5221 is provided with a bending segment 5222 which protrudes towards the loading position. The third driving component 523 is arranged at one side of the sliding chute 5221 away from the feeding mechanism 100, a driving direction of the third driving component 523 is identical to an extending direction of the sliding chute 5221, the third driving component 523 drives any of the loading assemblies 521 to slide to the bending segment 5222, and the loading assembly 521 located at the bending segment 5222 is arranged to be aligned with the loading position. The sliding chute 5221 can improve fluency of switching between the plurality of loading assemblies 521 to the loading position, and shorten the switching time. The bending segment 5222 is arranged towards the loading position, which can shorten a distance between an outlet of the loading assembly 521 and the feeding mechanism 100, and the loading assembly 521 entering the bending segment 5222 can supply the spring string 2000 to the feeding mechanism 100. Using the third driving component 523 to drive the loading assemblies 521 to move in the sliding chute 5221 can realize an effect of automatically switching the plurality of loading assemblies 521 and improve the convenience of switching.

Illustratively, the third driving component 523 includes a power mechanism 5231 and a conveyor belt 5232. The conveyor belt 5232 is arranged on one side of the sliding chute 5221 away from the feeding mechanism 100. The power mechanism 5231 may be a motor, etc. The power mechanism 5231 rotates forwards or backwards to drive the conveyor belt 5232 to move between two ends of the sliding chute 5221. The plurality of loading assemblies 521 are arranged on the conveyor belt 5232, and the conveyor belt 5232 drives the loading assemblies 521 to move and enables one of the loading assemblies 521 to enter the bending segment 5222 along the sliding chute 5221.

Optionally, the plurality of loading assemblies 521 are arranged along the second direction y. In this case, the sliding chute 5221 may be arranged extending along the second direction y. A protruding direction of the bending segment 5222 may be perpendicular to the second direction, that is, the bending segment may protrude in the first direction x (for example, negative x-axis direction as shown in FIG. 9). Similarly, the conveyor belt 5232 may also be arranged extending along the second direction y, and the conveyor belt 5232 may be arranged in parallel with the sliding chute 5221.

Optionally, in order to further improve sliding fluency of the loading assemblies 521 in the sliding chute 5221, the loading assemblies 521 may also be connected with the sliding chute 5221 through a roller 525, that is, the roller 525 is connected to a bottom part of each of the loading assemblies 521, and the roller 525 is slidably arranged in the sliding chute 5221, thereby reducing the friction between the loading assembly 521 and the sliding chute 5221 and enabling the loading assembly 521 to move more smoothly in the sliding chute 5221.

In some embodiments, the loading mechanism 520 further includes a plurality of pressing plates 524, each of the pressing plates 524 is arranged at a top part of a respective one of the loading assemblies 521, each of the pressing plates 524 is movable in the third direction z, and configured for abutting against a top part of the respective spring string 2000. By arranging the pressing plates 524, which can clamp the respective spring strings along the axial direction of the respective spring strings 2000 together with the respective loading assemblies 521, the spring strings 2000 can be prevented from bouncing during the loading process and improving the stability of the loading process of the spring strings 2000. The pressing plates 524 are movable in the third direction z, so that a height of the loading mechanism 520 can be adjusted, which facilitates to accommodate spring strings 2000 with different heights.

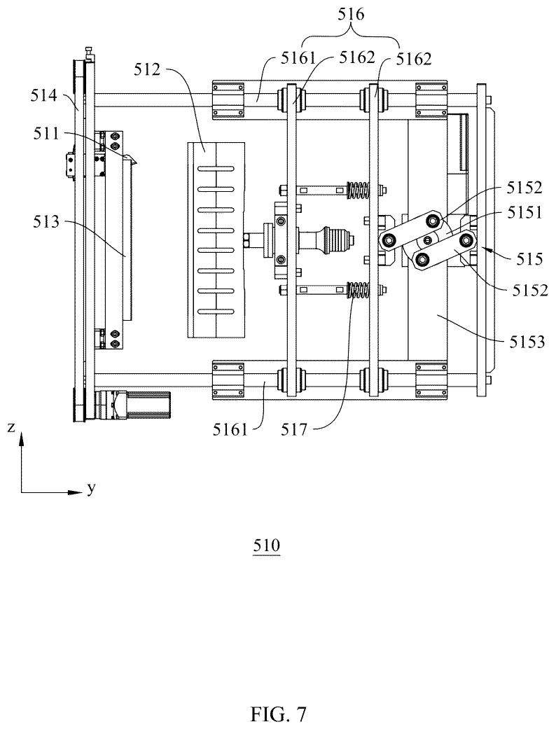

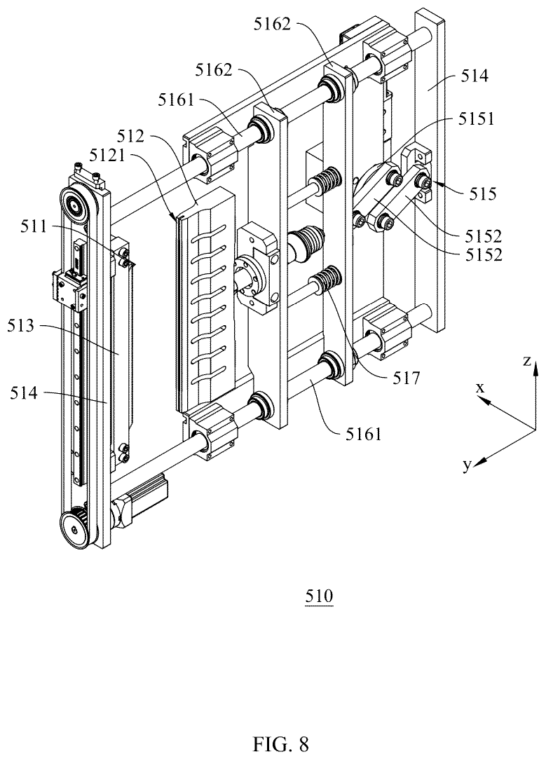

In some embodiments, please refer to FIG. 7 and FIG. 8. The welding and cutting mechanism 510 is arranged between the feeding mechanism 100 and the loading mechanism 520. The welding and cutting mechanism 510 is configured for cutting a continuous spring string 2000 into preset lengths. The welding and cutting mechanism 510 includes a third cutter 511, an ultrasonic welding head 512 and a welding blade 513 which are arranged in pair. The ultrasonic welding head 512 and the welding blade 513 are movable away from each other for the spring string 2000 to pass through. Surfaces of the welding blade 513 and the ultrasonic welding head 512 which are in contact with each other are provided with a cutting groove 5121 through which the third cutter 511 passes. When the ultrasonic welding head 512 and the welding blade 513 approach each other, the third cutter 511 passes through the cutting groove 5121 and cuts off the spring string 2000. By using the welding and cutting mechanism 510, the continuous spring string 2000 can be cut to the preset length, so that the length of the spring string 2000 can meet requirements of specification design of the bed mesh 2100. The third cutter 511 can cut the fabric between two adjacent springs at the position with the preset length, thus cutting off the spring string 2000. Typically, the spring string 2000 is formed by wrapping a plurality of springs with fabric. After the fabric between two adjacent springs is welded, each spring can be separated in an independent fabric pocket. Therefore, a cutting position of the third cutter 511 is usually on a welding seam between two adjacent springs, so that the fabric of the spring string 2000 can be prevented from unraveling after cutting. To further prevent fabric unraveling caused by weak original welding seams of the spring string 2000, the welding blade 513 and the ultrasonic welding head 512 perform a secondary welding operation on the fabric before the third cutter 511 performs cutting, so as to ensure that the two layers of fabric between the adjacent springs can be welded firmly. The welding blade 513 and the ultrasonic welding head 512 can move toward each other and clamp the fabric of the spring string 2000, and the two layers of fabric are welded under the effect of ultrasonic vibration. Because the surfaces of the welding blade 513 and the ultrasonic welding head 512 that are in contact with each other are provided with the cutting groove 5121, and the cutting groove 5121 divides the welding blade 513 and the ultrasonic welding head 512 into two parts. When the welding blade 513 and the ultrasonic welding head 512 performs welding cooperatively, two adjacent welding seams can be formed, and there is a gap between the two welding seams. The third cutter 511 enters the gap to cut the two welding seams apart, so that front and rear positions of the cut on the spring string 2000 both have one welding seam, thus effectively avoiding the fabric of the spring string 2000 from unraveling. Optionally, the third cutter 511 may extend along a length direction of the cutting groove 5121, and when the ultrasonic welding head 512 and the welding blade 513 contact each other to clamp the fabric, the third cutter 511 cuts off the fabric. Alternatively, in other examples, as shown in FIG. 7 and FIG. 8, a length of the third cutter 511 is smaller than a height of the fabric, and the motor is used to drive the third cutter 511 to move along the cutting groove 5121, thereby cutting off the fabric.

Optionally, a relative moving direction of the welding blade 513 and the ultrasonic welding head 512 may be perpendicular to a feeding and conveying direction of the spring string 2000, that is, the ultrasonic welding head 512 moves toward or away from the welding blade 513 along the second direction y.

In some embodiments, the welding and cutting mechanism 510 further includes a fixing frame 514, and a fourth driving component 515 and an installing member 516 arranged on the fixing frame 514. The welding blade 513 is fixedly arranged on the fixing frame 514, the ultrasonic welding head 512 is slidably arranged on the fixing frame 514 through the installing member 516, and the fourth driving component 515 drives the ultrasonic welding head 512 to move toward or away from the welding blade 513. The ultrasonic welding head 512 is elastically connected to the installing member 516 through an elastic part 517, and the elastic part 517 serves as a buffer when the ultrasonic welding head 512 presses against the welding blade 513. Through the sliding connection between the ultrasonic welding head 512 and the fixing frame 514 via the installing member 516, the ultrasonic welding head 512 can slide under the driving action of the fourth driving component 515, thereby automatically cooperating with the welding blade 513 to complete welding. When welding, the ultrasonic welding head 512 needs to press against the welding blade 513, so that there is a certain pressing force between the ultrasonic welding head and the welding blade, which ensures that the ultrasonic welding head 512 and the welding blade 513 can be attached to each other to form a good welding effect. The elastic connection between the ultrasonic welding head 512 and the installing member 516 helps to avoid direct rigid contact between the ultrasonic welding head 512 and the welding blade 513. When the ultrasonic welding head 512 presses against the welding blade 513, the elastic part 517 provides buffering, thereby preventing impact or abrasion between the two components and extending their service life. Exemplarily, the fourth driving member 515 may be a motor or another type of power mechanism, and the elastic member 517 may be a spring or the like.

Optionally, the installing member 516 includes a pair of guide rails 5161 and two first connecting rods 5162 arranged at an interval. The pair of guide rails 5161 are fixedly arranged on upper and lower sides of the fixing frame 514, and an extending direction of the guide rails 5161 is the same as a moving direction of the ultrasonic welding head 512. Two ends of each of the first connecting rods 5162 are slidably connected to the two guide rails 5161 respectively, and the first connecting rods 5162 are arranged perpendicular to the guide rails 5161. The two first connecting rods 5162 are connected with each other through an elastic part 517 (such as a spring), the ultrasonic welding head 512 is arranged on one of the first connecting rods 5162, and the fourth driving component 515 is arranged on the other first connecting rod 5162. The fourth driving component 515 drives one first connecting rod 5162 to slide, and the driving force is transmitted to the other first connecting rod 5162 through the elastic part 517, thus driving the ultrasonic welding head 512 to move. Using a guiding function of the guide rails 5161, the ultrasonic welding head 512 can move more stably, and stability and abutting accuracy of the ultrasonic welding head 512 and the welding blade 513 can be improved. Optionally, the fourth driving component 515 may include a swiveling structure 5151 (such as a rotating motor) and a second connecting rod 5152. One end of the second connecting rod is rotatably connected to an eccentric position of the swiveling structure 5151, and the other end of the second connecting rod 5152 is rotatably connected to the first connecting rod 5162 far away from the ultrasonic welding head 512. It can be understood that the slewing structure 5151, the second connecting rod 5152 and the first connecting rods 5162 constitute a crank-slider mechanism. Under an action of a rotary motion output by the swiveling structure, the second connecting rod 5152 converts the rotary motion into a linear motion through a swinging action, thereby driving the first connecting rod 5162 to move linearly, so as to realize movement of the ultrasonic welding head 512 toward or away from the welding blade 513. Optionally, the swiveling structure 5151 of the fourth driving component 515 may be fixedly connected to the fixing frame 514. Alternatively, in other examples, the swiveling structure 5151 may also be slidably installed on the fixing frame 514. For example, the swiveling structure 5151 is fixed on an installing plate 5153, and the installing plate 5153 is slidably connected with the fixing frame 514. Two second connecting rods 5152 may be provided. One end of each of the two second connecting rods 5152 is hinged on the eccentric position of the swiveling structure 5151, the other end of one of the two second connecting rods 5152 is hinged with the first connecting rod 5162, while the other end of the other second connecting rod 5152 is hinged on the fixing frame 514. Under the rotation of the swiveling structure 5151, the installing plate 5153 and the first connecting rod 5162 are driven to slide relative to the fixing frame 514, so that the ultrasonic welding head 512 can move toward or away from the welding blade 513.

In some embodiments, please refer to FIG. 2 and FIG. 6. The bridging assembly 530 is arranged on one side of the welding and cutting mechanism 510 facing the feeding mechanism 100. The bridging assembly 530 includes a fifth driving component 531 and a pair of clamping plates 532. The fifth driving component 531 drives the clamping plates 532 to reciprocate between the feeding mechanism 100 and the welding and cutting mechanism 510 in the first direction x. The clamping plates 532 are capable of passing through the welding and cutting mechanism 510 and are configured for clamping the spring string 2000 at the loading position, and the clamping plates 532 pull the spring string 2000 and feed the spring string to the feeding mechanism 100. By means of the clamping action of the clamping plates 532 on the spring string 2000, and since the clamping plates 532 can reciprocate between the feeding mechanism 100 and the welding and cutting mechanism 510, the spring string 2000 can be clamped by the clamping plates 532 after passing through the welding and cutting mechanism 510 and dragged into the feeding mechanism 100 under a pulling action of the clamping plates 532, thus realizing the smooth transition of the spring string 2000 from the loading mechanism 520 to the feeding mechanism 100 and improving the stability and the reliability of the spring string 2000 during moving. It can be understood that the pair of clamping plates 532 can move toward each other to clamp the spring string 2000 in the radial direction of the spring, and the two clamping plates 532 may also move away from each other to release the spring string 2000. For example, the pair of clamping plates 532 may be driven by a motor or another type of power mechanism to perform the clamping and releasing actions. After reaching the feeding mechanism 100, the spring string 2000 can continue to move under a conveying action of the feeding mechanism 100.

In some embodiments, referring to FIG. 4 and FIG. 5 again, the bed mesh bonding device 1000 further includes a fabric feeding mechanism 600. The fabric feeding mechanism 600 is arranged on one side of the assembly platform 200 away from the bed mesh channel 211. The fabric feeding mechanism 600 includes two material racks 610 and two press rollers 620. The material racks 610 are configured for supporting fabric rolls 3000 of the top surface fabric 3100 and the bottom surface fabric 3200 of the bed mesh 2100. The assembly platform 200 includes two third conveying parts 210 arranged at an interval in the third direction z. A bed mesh channel 211 is formed between the two third conveying parts 210, wherein one third conveying part 210 and one press roller 620 are configured for winding the top surface fabric 3100, while the other third conveying part 210 and the other press roller 620 are configured for winding the bottom surface fabric 3200. The two press rollers 620 respectively exert a pressing force on the two third conveying parts 210 towards the bed mesh channel 211, and the two third conveying parts 210 are capable of conveying the top surface fabric 3100 and the bottom surface fabric 3200 in the second direction y. On one hand, using the press rollers 620 to apply a pressing force to the third conveying parts 210 enables the two third conveying parts 210 to clamp the bed mesh 2100 along the axial direction of the spring to avoid the spring string 2000 from bouncing or deforming during bonding or conveying. On the other hand, the press rollers 620 can attach the surface fabrics (the top surface fabric 3100, and the bottom surface fabric 3200) to the surfaces of the third conveying parts 210. By means of the conveying action of the third conveying parts 210, the top surface fabric 3100 and the bottom surface fabric 3200 are respectively bonded to a top surface and a bottom surface of the bed mesh 2100.

Optionally, the glue gun 410 may be provided with a plurality of sprayers 411, and the sprayers 411 are arranged at an included angle. For example, one of the sprayers 411 is arranged towards the spring string 2000 or the bed mesh 2100, for example, with its spraying direction being in the second direction y, and the other one of the sprayers 411 is arranged towards the top surface fabric 3100 or the bottom surface fabric 3200, for example, with its spraying direction being in the third direction z. In this way, the glue gun 410 can spray glue on the top surface fabric 3100 and the bottom surface fabric 3200, which facilitates bonding between the surface fabrics and the bed mesh 2100.

In some embodiments, referring to FIG. 5, the bed mesh bonding device 1000 further includes fabric receiving mechanisms 700. Each of the fabric receiving mechanisms 700 is arranged between the respective fabric roll 3000 and the respective press roller 620. Each of the fabric receiving mechanisms 700 includes two cross beams 710 arranged at an interval in the third direction z, a heating structure 720 is arranged on one of the cross beams 710, the two cross beams 710 are movable towards each other to press against the surface fabric, and the heating mechanism is configured for thermally welding the two surface fabrics. When the fabric from the fabric roll 3000 is used up, a new fabric roll 3000 needs to be replaced, and the fabrics from the old and new fabric rolls 3000 need to be connected. Therefore, by arranging the fabric receiving mechanisms 700, the fabrics from the two fabric rolls 3000 can be thermally welded and connected, thereby enabling the replacement of the fabric roll 3000 and ensuring continuous fabric supply. Setting the heating structure 720 on one of the cross beams 710 can reduce space occupation of the heating structure 720 and make the structure of the fabric receiving mechanism more compact. The two cross beams 710 can move toward each other to press against the surface fabric, and the two surface fabrics can be connected under the combined effect of pressure and heat. Exemplarily, the heating structure 720 may be a heating wire, or the like.

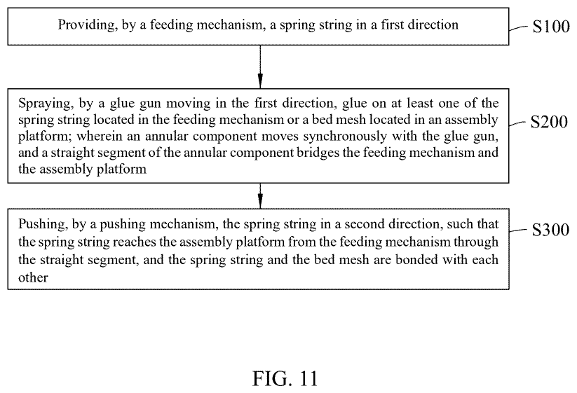

In a second aspect, referring to FIG. 11, the present disclosure further provides a bed mesh bonding method, including the following steps:
S100. Providing, by a feeding mechanism 100, a spring string 2000 in a first direction x;
S200. Spraying, by a glue gun 410 moving in the first direction, glue on at least one of the spring string 2000 located in the feeding mechanism 100 or a bed mesh 2100 located in an assembly platform 200; wherein an annular component 420 moves synchronously with the glue gun 410, and a straight segment 421 of the annular component 420 bridges the feeding mechanism 100 and the assembly platform 200; and
S300. Pushing, by a pushing mechanism 300, the spring string 2000 in a second direction y, such that the spring string 2000 reaches the assembly platform 200 from the feeding mechanism 100 through the straight segment 421, and the spring string 2000 and the bed mesh 2100 are bonded with each other.

In this way, the feeding mechanism 100 provides the spring string 2000, and the spring string 2000 can be arranged in place in the feeding mechanism 100 in the first direction x. When the glue gun 410 sprays glue on the spring string 2000 and the bed mesh 2100, the annular component 420 moves synchronously with the glue gun 410. Therefore, the straight segment 421 of the annular component 420 can be filled in the gap between the feeding mechanism 100 and the assembly platform 200. In this case, the annular component 420 will not block or interfere with the movement of the pushing mechanism 300, the spring string 2000 and the glue gun 410, and it can also be ensured that the spring string 2000 is smoothly transferred when being pushed to the assembly platform 200, avoiding the spring string 2000 from being stuck or falling into the gap. Finally, the spring string 2000 is pushed into the assembly platform 200 along the second direction y by the pushing mechanism 300, so as to realize the bonding between the spring string 2000 and the bed mesh 2100.

The embodiments of the present disclosure are described in detail with reference to the drawings above, but the present disclosure is not limited to the above embodiments, and various changes may also be made within the knowledge scope of those of ordinary skills in the art without departing from the purpose of the present disclosure. Moreover, in case of no conflict, the embodiments in the present disclosure and the features in the embodiments may be arbitrarily combined with each other.

What is claimed is:

1. A bed mesh bonding device, comprising:
a feeding mechanism configured for providing a spring string;
an assembly platform arranged at a first side of the feeding mechanism in a second direction, wherein the assembly platform is configured for bearing a bonded bed mesh;
a pushing mechanism arranged at a second side of the feeding mechanism in the second direction, wherein the pushing mechanism is configured for pushing the spring string from the feeding mechanism to the assembly platform; and
a glue spraying assembly arranged between the feeding mechanism and the assembly platform, wherein the glue spraying assembly comprises a glue gun and an annular component, the glue gun is connected to the annular component and is configured to reciprocate in a first direction and to spray glue to the bed mesh or the spring string, the annular component is configured to move synchronously with the glue gun and comprises at least one straight segment, and the straight segment is configured to bridge the feeding mechanism and the assembly platform during movement of the glue gun, so as to smoothly transfer the spring string from the feeding mechanism to the assembly platform.

2. The bed mesh bonding device according to claim 1, wherein the feeding mechanism comprises two first conveying parts arranged in a third direction, the two first conveying parts are configured for clamping the spring string and conveying the spring string in the first direction, the two first conveying parts define a first feeding channel, and an interval between the first conveying parts is adjustable; and
the assembly platform comprises two third conveying parts arranged in the third direction, the two third conveying parts are configured for clamping the bed mesh and conveying the bed mesh in the second direction, the two third conveying parts define a bed mesh channel, and the bed mesh channel is communicated with the first feeding channel in the second direction.

3. The bed mesh bonding device according to claim 2, wherein a bridging channel is arranged in a gap between the bed mesh channel and the first feeding channel, the straight segment of the annular component is arranged on one side of the bridging channel in the third direction, and a transition plate is arranged on another side of the bridging channel.

4. The bed mesh bonding device according to claim 1, wherein the glue spraying assembly further comprises a first driving component, the first driving component is configured for driving the glue gun to reciprocate and simultaneously driving the annular component to move, and when the glue gun moves to any end of the assembly platform in the first direction, the annular component fills a gap between the feeding mechanism and the assembly platform in the first direction.

5. The bed mesh bonding device according to claim 1, wherein the annular component is provided with a notch, the glue gun is arranged on the notch of the annular component, and the annular component is movable in a circumferential direction to keep synchronization with movement of the glue gun in the first direction.

6. The bed mesh bonding device according to claim 1, wherein an annular plane enclosed by the annular component is perpendicular to the second direction, and the annular component comprises at least one of a chain plate, a conveyor chain or a conveyor belt.

7. The bed mesh bonding device according to claim 2, wherein the feeding mechanism further comprises two second conveying parts arranged in the third direction, the second conveying parts are configured for clamping the spring string along an axial direction of the spring string, the two second conveying parts defines a second feeding channel, the second conveying parts are arranged upstream of the first conveying parts in the first direction, the second feeding channel is communicated with the first feeding channel, and a conveying speed difference between the second conveying parts and the first conveying parts is adjustable to adjust an interval between adjacent springs in the spring string.

8. The bed mesh bonding device according to claim 7, wherein the feeding mechanism further comprises a first transmission part and a second transmission part, the first transmission part is configured to drive the two first conveying parts to convey synchronously, and the second transmission part is configured to drive the two second conveying parts to convey synchronously.

9. The bed mesh bonding device according to claim 7, wherein the assembly platform comprises a second driving component, and a bearing module and a movable module arranged at an interval in the third direction, the bed mesh channel is formed between the bearing module and the movable module, the bed mesh channel is configured for conveying the bed mesh in the second direction, and the driving component is configured to drive the movable module to move in the third direction to adjust a height of the bed mesh channel; and
one of the first conveying parts and one of the second conveying parts located on a same side as the movable module in the third direction are connected to the movable module and follow the movable module to move in the third direction.

10. The bed mesh bonding device according to claim 9, wherein one of the third conveying parts is arranged on the movable module, the movable module further comprises a first roller and a first cutter, the third conveying part arranged on the movable module is configured for winding a top surface fabric and clamping a top part of the bed mesh, the first roller is arranged downstream of the third conveying part in a conveying direction, the first cutter is arranged between the third conveying part and the first roller, and the first roller is configured for driving the first cutter to move in the first direction to cut off the top surface fabric of the bed mesh.

11. The bed mesh bonding device according to claim 10, wherein another of the third conveying parts is arranged on the bearing module, the bearing module further comprises a second roller and a second cutter, the third conveying part arranged on the bearing module is configured for winding a bottom surface fabric, the second roller is correspondingly arranged below the first roller in the third direction, the second cutter is correspondingly arranged below the first roller in the third direction, and the second roller is configured for driving the second cutter to move in the first direction to cut off the bottom surface fabric of the bed mesh.

12. The bed mesh bonding device according to claim 9, wherein the second driving component comprises a first power mechanism and a plurality of screw stems extending in the third direction, the movable module is movably connected to the screw stems, and the first power mechanism is configured for driving the screw stems to rotate to drive the movable module to move in the third direction.

13. The bed mesh bonding device according to claim 1, wherein the bed mesh bonding device further comprises a feeding device, the feeding device is arranged upstream of the feeding mechanism in a conveying direction of the spring string, the feeding device comprises a welding and cutting mechanism, a loading mechanism and a bridging assembly, the loading mechanism comprises a plurality of loading assemblies, the loading assemblies are configured for respective spring strings to pass through, any one of the loading assemblies is movable to be aligned with a lo ading position, and the loading position is communicated with an inlet of the feeding mechanism.

14. The bed mesh bonding device according to claim 13, wherein the loading mechanism comprises a supporting plate and a third driving component, a sliding chute is arranged on the supporting plate, the plurality of loading assemblies are slidably arranged in the sliding chute, the sliding chute is provided with a bending segment which protrudes towards the loading position, the third driving component is arranged at one side of the sliding chute away from the feeding mechanism, a driving direction of the third driving component is identical to an extending direction of the sliding chute, the third driving component is configured to drive any of the loading assemblies to slide to the bending segment, such that the respective loading assembly located at the bending segment is arranged to be aligned with the loading position.

15. The bed mesh bonding device according to claim 14, wherein the loading mechanism further comprises a plurality of pressing plates, each of the pressing plates is arranged at a top part of a respective one of the loading assemblies, each of the pressing plates is movable in the third direction and configured for abutting against a top part of the respective spring string.

16. The bed mesh bonding device according to claim 13, wherein the welding and cutting mechanism is arranged between the feeding mechanism and the loading mechanism, and is configured for cutting a continuous spring string into preset lengths, the welding and cutting mechanism comprises a third cutter, and an ultrasonic welding head and a welding blade which are arranged in pair, the ultrasonic welding head and the welding blade are movable away from each other for the spring string to pass through, surfaces of the welding blade and the ultrasonic welding head which are in contact with each other are provided with a cutting groove through which the third cutter passes, and when the ultrasonic welding head and the welding blade approach each other, the third cutter is able to pass through the groove and cut off the spring string.

17. The bed mesh bonding device according to claim 16, wherein the welding and cutting mechanism further comprises a fixing frame, and a fourth driving component and an installing member arranged on the fixing frame, the welding blade is fixedly arranged on the fixing frame, the ultrasonic welding head is slidably arranged on the fixing frame through the installing member, and the fourth driving component is configured for driving the ultrasonic welding head to move toward or away from the welding blade; and
the ultrasonic welding head is elastically connected to the installing member through an elastic part, and the elastic part serves as a buffer when the ultrasonic welding head presses against the welding blade.

18. The bed mesh bonding device according to claim 13, wherein the bridging assembly is arranged on one side of the welding and cutting mechanism facing the feeding mechanism, the bridging assembly comprises a fifth driving component and a pair of clamping plates, the fifth driving component is configured for driving the clamping plates to reciprocate between the feeding mechanism and the welding and cutting mechanism in the first direction, the clamping plates are capable of passing through the welding and cutting mechanism and are configured for clamping the spring string at the loading position, pulling the spring string and feeding the spring string to the feeding mechanism.

19. The bed mesh bonding device according to claim 1, wherein the bed mesh bonding device further comprises a fabric feeding mechanism arranged on one side of the assembly platform away from a bed mesh channel, the fabric feeding mechanism comprises two material racks and two press rollers, the material racks are configured for supporting fabric rolls of a top surface fabric and a bottom surface fabric of the bed mesh, the assembly platform comprises two third conveying parts arranged at an interval in a third direction, the bed mesh channel is formed between the two third conveying parts, one of the third conveying parts and one of the press rollers are configured for winding the top surface fabric, another of the third conveying parts and another of the press rollers are configured for winding the bottom surface fabric, the two press rollers are configured respectively for exerting a pressing force on the two third conveying parts towards the bed mesh channel, such that the two third conveying parts are capable of conveying the top surface fabric and the bottom surface fabric in the second direction;
wherein the bed mesh bonding device further comprises fabric receiving mechanisms, each of the fabric receiving mechanisms is arranged between the respective fabric roll and the respective press roller, and comprises two cross beams arranged at an interval in the third direction, a heating structure is arranged on one of the cross beams, the two cross beams are movable towards each other to press against the surface fabric, and the heating mechanism is configured for thermally welding the two surface fabrics.

20. A bed mesh bonding method, comprising:
providing, by a feeding mechanism, a spring string in a first direction;
spraying, by a glue gun moving in the first direction, glue on at least one of the spring string located in the feeding mechanism or a bed mesh located in an assembly platform; wherein an annular component moves synchronously with the glue gun, and a straight segment of the annular component bridges the feeding mechanism and the assembly platform; and
pushing, by a pushing mechanism, the spring string in a second direction, such that the spring string reaches the assembly platform from the feeding mechanism through the straight segment, and the spring string and the bed mesh are bonded with each other.
